(19) United States
(12) Patent Application Publication
(10) Pub. No.: US 2024/0342684 A1
(43) Pub. Date: Oct. 17, 2024

(54) NANOCATALYZED SORBENTS FOR DIRECT AIR CAPTURE OF CARBON DIOXIDE

(71) Applicant: Xiwang Qi, Scottsdale, AZ (US)

(72) Inventor: Xiwang Qi, Scottsdale, AZ (US)

(21) Appl. No.: 18/135,144

(22) Filed: Apr. 15, 2023

(51) Int. Cl. B01J 20/26; B01D 53/04; B01D 53/86; B01D 53/96; B01J 20/34; B01J 23/78; B01J 35/00; B01J 35/02; B01J 35/04

(52) U.S. Cl. CPC B01J 20/261; B01D 53/0438; B01D 53/0446; B01D 53/8671; B01D 53/96; B01J 20/3425; B01J 20/3483; B01J 23/78; B01J 35/23; B01J 35/50; B01J 35/56; B01D 2253/20; B01D 2253/202; B01D 2253/25; B01D 2253/3425; B01D 2255/2047; B01D 2255/20761; B01D 2257/504

(57) ABSTRACT

This invention relates to solid nanocatalyzed sorbents for direct air capture of CO₂. The sorbent structure consists of porous support structures having a plurality of pores and channels formed therethrough providing a large area of surfaces carrying nanosized CO₂ adsorbent material embedded with nanocatalyst particles, enabling a fast CO₂ adsorption and desorption kinetics and reduced desorption temperature, therefore an energy efficient and low-cost direct air CO₂ capture process.

### CROSS-REFERENCE TO RELATED APPLICATION

This application claims priority of Provisional Application Ser. No. 63/333,279 filed in the United States Patent and Trademark Office on Apr. 21, 2022, and which addresses the same subject matter.

### FILED OF THE INVENTION

The present invention relates to solid nanocatalyzed sorbents for direct carbon dioxide (CO₂) capture from air. More particularly, the present invention relates to the utilization of nanocatalyst particles embedded in the solid sorbent structure to boost the CO₂ adsorption and desorption rate and to reduce the desorption temperature required to release the adsorbed CO₂ from the nanocatalyzed sorbents.

### BACKGROUND OF THE INVENTION

Climate change includes both global warming driven by human-induced emissions of greenhouse gases and the resulting large-scale shifts in weather patterns. Since the mid-20th century, humans have had an unprecedented impact on Earth's climate. Increases in temperature are leading to more frequent heat waves and wildfires in recent years, while melting permafrost, glacial retreat, and sea ice loss all pose significant environmental catastrophe if not addressed in the coming decades. The main greenhouse gas of concern is CO₂, which is emitted from the burning of fossil fuels (coal, oil, and natural gas) for energy consumption, as well as from activity in agriculture, deforestation, and manufacturing. The International Panel on Climate Change (IPCC) estimates that approximately 10 gigatons of net CO₂ removal per year by 2050 is needed to keep global temperatures from rising 1.5-2 C to avoid the worst effects of climate change. It is commonly agreed that emissions reduction alone is not enough, and that society needs to employ carbon capture technology to collectively solve the imminent climate change problem.

Currently, most carbon capture technologies being developed are used to prevent the release of carbon dioxide (CO₂) into the atmosphere near a source of CO₂, such as power plants, ethanol production plants, or other industrial facilities where high concentrations of CO₂ are being released into the atmosphere. These technologies are typically used for flue gas CO₂ emission reduction. The concentration of CO₂ in flue gas emissions varies, but is usually at high concentrations (10˜20% CO₂). Examples of these technologies include liquid solvent scrubbing and base chemical reactions using concentrated NaOH or Na₂CO₃ solutions. Because of the high costs and corrosive nature associated with aqueous solution approaches, in recent years solid sorbent approaches have received a lot of attention due to the potential for low energy input, low operating costs, as well as eco-friendly operation.

Another technology is direct air capture (DAC). In direct air capture, CO₂ is captured from the atmosphere where the CO₂ concentration is approximately 400 ppm, substantially less than in flue gasses. The use of solid sorbents is becoming more prevalent in DAC technologies. A single unit with solid sorbents is used, where adsorption and desorption (regeneration) of CO₂ happen one after another in a repeating cycle. After saturation, the solid sorbent is regenerated by thermal heating of the system to a certain temperature, mostly above 120 C, to release the CO₂ from the sorbent. The system is then cooled down to return the solid sorbent to ambient conditions to start another cycle. In the state of the art direct air capture process, the thermal energy requirement for heating the system in the regeneration process accounts for roughly 80% of the operation energy cost, also the CO₂ capture capability per unit time is low with the state of the art DAC sorbent because of the slow adsorption kinetics under DAC condition at very low concentration of CO₂ (400 ppm), making the cost of per ton CO₂ captured prohibitively high (>$600/ton), which prevents economical large-scale implementation. Therefore, there is an urgent need to develop a new direct air capture technology which can capture low concentration CO₂ (400 ppm) at faster speed, bigger capacity per unit volume, lower desorption temperature and at an affordable cost, ideally below $100 for per ton CO₂ captured at scale.

It would be highly advantageous, therefore, to remedy the foregoing and other deficiencies inherent in the prior art.

The present invention is to provide a nanocatalyzed solid sorbent material and method for direct air capture of CO₂ with fast adsorption kinetics of CO₂ and energy-efficient and fast desorption of CO₂ from saturated sorbents.

### SUMMARY OF THE INVENTION

This invention relates to nanocatalyzed sorbents for direct air capture of CO₂. The sorbents consist of nanosized CO₂ adsorbent materials integrated in nanoporous supports with embedded nanocatalyst particles in the sorbent structure to boost the CO₂ adsorption and desorption speed, thus enabling a fast, highly efficient and economical CO₂ capture process. Briefly to achieve the desired objects and advantages of the instant invention in accordance with a preferred embodiment thereof, a method of direct air capture of CO₂ from air associated with this nanocatalyzed sorbent is provided. The steps of the method include having an upstream end and an opposing downstream end, providing a sorbent structure carried within and filling the chamber, the sorbent structure including packed bed of nanocatalyzed sorbent pellets or a nanocatalyzed honeycomb monolith sorbent structure and the like. The porous nature of these structures allows the flow of air therethrough while ensuring contact with adsorbent materials. A motor fan is provided and coupled to the downstream end of the chamber to create an air flow from the upstream end to the downstream end and draw air through the chamber and the sorbent structure carried therein. The motor fan is turned to an on configuration to create a flow of ambient air through the chamber and the sorbent structure carried therein. The ambient air is drawn into the upstream end of the chamber and passes through the pores and channels of the porous support structure with the CO₂ within the air contacting and being adsorbed by the CO₂ adsorbent material. The CO₂ depleted air is passed out through the downstream end. The airflow is stopped from entering the upstream end of the chamber when the adsorption of CO₂ by the CO₂ adsorbent material has reached a desired level. An electric heating unit is turned to an on configuration to heat the sorbent material with adsorbed CO₂ until a desorption temperature is reached, releasing the CO₂ out the downstream end and regenerating the CO₂ adsorbent material. The heating unit is then turned to an off configuration once desorption of the CO₂ from sorbent material is complete. Airflow into the upstream end is reestablished and the process is repeated.

### BRIEF DESCRIPTION OF THE DRAWING

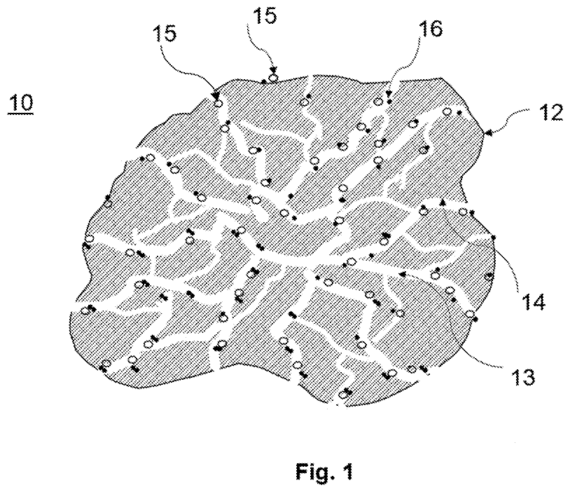

Specific object and advantages of the invention will become readily apparent to those skilled in the art from the following detailed description of a preferred embodiment thereof, taken in conjunction with the drawing as shown in FIG. 1, a sectional schematic view of an example of a nanocatalyzed sorbent structure in pellet form.

### DETAILED DESCRIPTION

This invention relates to nanocatalyzed sorbents for direct air capture of CO₂ with drastically enhanced adsorption and desorption rate and therefore greatly reduced cycle time and energy consumption compared to the state of art direct air capture sorbent process. The nanocatalyzed sorbents in this invention consist of CO₂ adsorbent materials, nanocatalyst particles and nanoporous supports on which the CO₂ adsorbent materials and nanocatalysts are coated and embedded. The porous supports are made into physical forms of pellets, granules, or honeycomb monolith.

Referring to FIG. 1, a nanocatalyzed sorbent pellet 10 is illustrated in a simplified cross-sectional schematic. Pellet 10 includes nanoporous support structure 12 having a multitude of nanopores and channels 13 formed therethrough providing a large area of surfaces 14. Nanoporous support structure 12 consists of composite materials, including materials chosen from activated carbon, alumina, silica, magnesium oxide, cerium oxide, zeolite, cordierite or combinations thereof. Nanosized CO₂ adsorbent material 15 and nanosized catalyst 16 coat surfaces 14 of each pellet 10 to form the specialized “Nano-in-Nano” sorbent structure of this invention. CO₂ adsorbent materials 15 are hybrid amines, including at least two amine or polyamine components chosen from the list of monoethanolamine, methyldiethanolamine, diethanolamine, ethylenediamine, aminomethyl propanol, diisopropylamine, triethylenetetramine, diethylenetriamine, triethanolamine, tetraethylenepentamine, piperazine, as well as amino group containing polymers including polyethyleneimine, polyacrylamide and chitosan. The nanosized catalysts are chosen from a group consisting of iron, cobalt, nickel, copper, zinc, silver, phosphorus, magnesium, manganese, sodium, potassium, calcium, platinum, palladium, rhodium, ruthenium, cerium, their corresponding oxides, and combinations.

The method of direct air capture of CO₂ from air associated with this nanocatalyzed sorbent is provided. The steps of the method include having an upstream end and an opposing downstream end, providing a sorbent structure carried within and filling the chamber. The sorbent structure includes a packed bed of nanocatalyzed sorbent pellets or a honeycomb monolith structure. A motor fan is provided and coupled to the downstream end of the chamber to create an air flow from the upstream end to the downstream end and draw air through the chamber and the sorbent structure carried therein. Specifically, when the ambient air flows through the sorbent structure, the CO₂ in the air is in close contact with the sorbents and chemically binds to the CO₂ adsorbent materials. During this chemical adsorption process, the nanocatalysts embedded in the sorbent structure drastically reduce the activation energy required for the reaction to take place and greatly speed up the process otherwise it's very slow at room temperature for the state of the art sorbents. As a result, in this invention the CO₂ capture cycle time decreases and capacity per unit time increases, and the desorption temperature required to release the captured CO₂ also decreases, and therefore the overall energy consumption as well as capital cost per ton CO₂ captured decrease dramatically as compared to the state of the art DAC sorbent process.

An example of a nanocatalyzed sorbent including nanosized CO₂ adsorbent material and nanosized catalyst coated on a porous support structure was synthesized by a two-step method. Firstly, activated carbon or carbon precursor, HSA zeolite (PIDC, Ann Arbor, MI), MI-386 Al₂O₃(PIDC, Ann Arbor, MI), corn starch (Argo, Illinois) and methyl cellulose were mixed into paste and extruded into pellets. The pellets are dried in air at 60 C for 24 hours followed by calcination and activation in an atmosphere-controlled furnace at 800-900 C to form the high surface area porous nanostructured composite support. Secondly, catalyst precursors including magnesium salt and copper salt are dissolved in water and dispersed into hybrid amine solution consisting of monoethanolamine, diethanolamine, diethylenetriamine and polyacrylamide (Dow Chemicals, Michigan). The dispersed catalyst accounts for 1 wt % of the total solution. The solution was coated onto the porous nanostructured composite support prepared in first step followed by drying and thermal conditioning steps. 14 g of the above prepared sorbent was tested for direct CO₂ capture from air in an 80 L closed air chamber with circulation fan. The CO₂ concentration was reduced to below 200 ppm in 3.5 minutes from an initial 416 ppm. The nanocatalyzed sorbent with adsorbed CO₂ in this invention can be easily regenerated by heating the sorbent to ˜75 C, a much lower CO₂ desorption temperature as compared to over 120 C in the state of the art sorbent process.

The nanocatalyzed DAC sorbent 10 provides a unique “Nano-in-Nano” materials structure and synergetic configuration enabling an ultra-efficient and low-cost approach for direct CO₂ capture from air. While the primary application of this invention is for direct air capture of CO₂, it should be noted that this invention is not limited to direct air capture, it can also be used for point source CO₂ emission reductions in places such as power plants, cement and steel manufacturers, as well as transportation and oil and gas industries and the like.

The present invention is described above with reference to illustrative embodiments. Those skilled in the art will recognize that changes and modifications may be made in the described embodiments without departing from the nature and scope of the present invention. Various changes and modifications to the embodiments herein chosen for purposes of illustration will readily occur to those skilled in the art. To the extent that such modifications and variations do not depart from the invention, they are intended to be included within the scope thereof.

1. Nanocatalyzed sorbents for direct air capture of CO₂, comprising porous support structures carrying nanosized CO₂ adsorbent material embedded with nanocatalyst particles, and the porous support structure having a plurality of pores and channels formed therethrough providing a large area of surfaces coated by the CO₂ adsorbent material and nanocatalyst particles.

2. The nanocatalyzed sorbents as claimed in claim 1, wherein the CO₂ adsorbent materials are hybrid amines, consisting of at least two amine or polyamine components chosen from the list of monoethanolamine, methyldiethanolamine, diethanolamine, ethylenediamine, aminomethyl propanol, diisopropylamine, triethylenetetramine, diethylenetriamine, triethanolamine, tetraethylenepentamine, piperazine, as well as amino group containing polymers including polyethyleneimine, polyacrylamide and chitosan.

3. The nanocatalyzed sorbents as claimed in claim 1, wherein the porous support structures consist of composite materials, chosen from alumina, silica, activated carbon, zeolite, magnesium oxide, silicon carbide, cerium oxide, cordierite or combinations thereof.

4. The nanocatalyzed sorbents as claimed in claim 1, wherein said nanocatalysts are chosen from a group consisting of iron, cobalt, nickel, copper, zinc, silver, phosphorus, magnesium, manganese, sodium, potassium, calcium, platinum, palladium, rhodium, ruthenium, cerium, their corresponding oxides, and combinations.

5. The nanocatalyzed sorbents as claimed in claim 1, wherein porous supports are made into physical forms of pellets, granules, or honeycomb monolith.

6. A method of direct air capture of CO₂ comprising the steps of
providing a chamber having an upstream end and an opposing downstream end;
providing a nanocatalyzed sorbent structure carried within and filling the chamber, the sorbent structure including porous support structures carrying nanosized CO₂ adsorbent material embedded with nanocatalyst particles, and the porous support structure having a plurality of pores and channels formed therethrough providing a large area of surfaces coated by the CO₂ adsorbent material and nanocatalyst particles;
providing a motor fan coupled to the downstream end of the chamber to create an air flow from the upstream end to the downstream end and draw air through the chamber and the nanocatalyzed sorbent structure carried therein;
turning the motor fan to an on configuration to create a flow of ambient air through the chamber and the sorbent structure carried therein, the ambient air drawn into the upstream end of the chamber and passing through the pores and channels of the porous support structure with the CO₂ within the air contacting and being adsorbed by the CO₂ adsorbent material, the CO₂ depleted air passing out through the downstream end;
stopping the airflow from entering the upstream end of the chamber when the adsorption of CO₂ by the CO₂ adsorbent material has reached a desired level;
turning the electric heating unit to an on configuration to heat the nanocatalyzed CO₂ sorbent with adsorbed CO₂ until the desorption temperature is reached releasing the CO₂ out the downstream end and regenerating the CO₂ sorbent material;
turning the electric heating unit to an off configuration once desorption of the CO₂ from sorbent material is complete; and reestablishing airflow into the upstream end to repeat the process.

7. The method as claimed in claim 6 wherein the step of providing a nanocatalyzed sorbent structure including porous support structures includes forming the porous support structures from composite materials chosen from a group consisting of alumina, silica, activated carbon, zeolite, silicon carbide, magnesium oxide, cerium oxide, cordierite or combinations thereof.

8. The method as claimed in claim 6 wherein the step of providing a nanocatalyzed sorbent structure including CO₂ adsorbent material includes the step of providing nanosized CO₂ adsorbent material that are hybrid amines, consisting of at least two amine or polyamine components chosen from the list of monoethanolamine, methyldiethanolamine, diethanolamine, ethylenediamine, aminomethyl propanol, diisopropylamine, triethylenetetramine, diethylenetriamine, triethanolamine, tetraethylenepentamine, piperazine, as well as amino group containing polymers including polyethyleneimine, polyacrylamide and chitosan.

9. The method as claimed in claim 6 wherein the step of providing a nanocatalyzed sorbent structure including embedded nanocatalyst particles includes the step of providing nanocatalysts that are chosen from a group consisting of iron, cobalt, nickel, copper, zinc, silver, phosphorus, magnesium, manganese, sodium, potassium, calcium, platinum, palladium, rhodium, ruthenium, cerium, their corresponding oxides, and combinations.

10. The method as claimed in claim 6 wherein the step of providing porous support structures further includes providing porous support structures having the form of pellets, granules, or honeycomb monolith structures.
